(19) United States
(12) Patent Application Publication
(10) Pub. No.: US 2013/0302750 A1
(43) Pub. Date: Nov. 14, 2013

(54) DEVICE FOR PICKING AND PLACING SMALL PARTS, PARTICULARLY IN THE FIELD OF ODONTOLOGY OR MICROSURGERY

(71) Applicant: Philippe Bagur, Luzarches (FR)

(72) Inventor: Philippe Bagur, Luzarches (FR)

(21) Appl. No.: 13/981,006

(22) PCT Filed: Jan. 20, 2012
(86) PCT No.: PCT/FR2012/050122

§ 371 Date: Jul. 22, 2013

(30) Foreign Application Priority Data
Jan. 21, 2011 (FR) 1150480

(51) Int. Cl. A61C 3/00; A61C 5/08

(52) U.S. Cl. CPC A61C 3/00; A61C 5/08
USPC 433/163; 433/215; 433/218

(57) ABSTRACT

A tubular sleeve is configured to grasp a small part, move it, and place it in a correct location in a patient's mouth. The tubular sleeve comprises a picking end; a connection end having a connection end piece configured to connect to a suction system; and an inner part between the picking end and the connection end, the inner part being equipped with a sealing flap configured to cooperate with a control device to move the sealing flap between an open position and a closed position. The sealing flap, in the open position, allows passage of aspirated air flow from the suction system to pick up and suction the small part, and the sealing flap, in the closed position, blocks the aspirated air flow to separate the small part from the tubular sleeve.

### FIELD OF THE INVENTION

The present invention relates to a device for picking and placing small parts, in particular in the field of odontology or microsurgery.

### BACKGROUND

The picking, movement and placement in the mouth, specifically in the correct location, of very small parts such as posts, pivots, inlay cores, crowns or onlays, have always been problematic for dentists and surgeons.

To that end, practitioners either use their hands or more or less suitable instruments, such as pliers or tweezers.

These instruments do not, however, make it possible to rule out risks of the picked parts sliding, and those parts may fall on the ground or in the mouth, or even in a patient's throat, which is a major drawback.

To secure the picking and transport of small parts of this type and facilitate their placement in the mouth, it has already been proposed to modify the geometry of the pliers or tweezers, in particular by equipping them with more or less fine edges or adding non-slip fittings to them, in particular made from silicone.

To the same end, rods have already been proposed with an end equipped with an adhesive material serving to make it possible to grasp small parts. However, none of these means have been satisfactory during use.

### SUMMARY OF THE INVENTION

The present invention aims to resolve this drawback by offering practitioners a device capable of securing the picking and movement of small parts and facilitating their placement, and subsequently of a nature to greatly improve their working conditions and comfort.

According to the invention, such a device is characterized in that it is formed by a tubular sleeve, generally made from plastic, comprising a first end or picking end on the one hand and a second end or connection end provided with an end piece allowing it to be connected directly or indirectly to a suction system on the other hand, such as that equipping a dentist's chair.

According to the invention, the tubular sleeve is preferably provided at its picking end with a maintaining element allowing the aspirated air flow to pass, but making it possible to retain a small part.

This maintaining element may for example be made up of a foam or grate against which a small part previously picked up and suctioned by the air flow is pressed and is therefore retained without any risk of being driven into the inner part of the tubular sleeve toward the connection end piece and the suction system.

It should be noted that the device according to the invention may, if applicable, be designed to make it possible to incline or rotate the picked small part so as to present it in its final position very precisely.

The connection end piece of the tubular sleeve may be directly connected on a suction system such as the suction system of a dentist's chair, or by means of a connector such as a hose or another hollow sleeve, for example that of a suction mouth mirror.

According to the invention, the tubular sleeve is also equipped, in its inner part, with a sealing flap movable between an open position and a closed position in which it blocks the aspirated air flow.

Actuating the control means allows the practitioner to move said sealing flap between the open position and the closed position so as to allow the aspirated air flow to pass or completely or partially block it.

According to one non-limiting feature of the invention, these means can also be made up of a pushbutton protruding from the outer periphery of the tubular sleeve.

According to the invention, the tubular sleeve can be more or less rounded at its picking end and its diameter at that level may be larger or smaller than the largest dimension of the parts to be picked.

In all cases, these parts, which are all essentially light, even if certain crowns or certain inlay cores are relatively dense, may be picked up and suctioned by the air flow when the connection end piece is connected on a suction system, and be pressed against the picking end of the tubular sleeve or against the maintaining element to allow them to be transported to their final location safely and without any risk of falling.

According to the invention, the tubular sleeve is, however, preferably slender at its picking end to allow it to penetrate the tiniest spaces and facilitate precise placement of the grasped parts, in particular in a patient's mouth, even in areas that are very difficult to access.

It should be noted that the tubular sleeve may be rectilinear or have a bend at the picking end to allow it to be adapted to all cases of difficult access that may be encountered.

Furthermore and still with the same aim, this end may include an opening that is not axial, but lateral.

According to the invention, the tubular sleeve can also be equipped, at its picking end, with a fitting making it possible to tilt or rotate the grasped object. In the context of certain usage fields such as microsurgery, such a fitting may also be designed to make it possible to slice or cut, coagulate, cauterize, as an example, in order to grasp and remove small tumors.

The use of a picking and placement device according to the invention is particularly easy and comfortable for practitioners.

In fact, after having connected the connection end piece on a suction system and placed the sealing flap in the open position, the latter must approach and come into contact with the picking end of the tubular sleeve of the part to be grasped and placed, which is thus automatically captured and suctioned by the air flow and therefore maintained at that level on the tubular sleeve completely safely.

The practitioner can then very easily transport the part thus maintained to its final location and position it very precisely in that location.

It then remains only to actuate the pushbutton to move the sealing flap to the closed position so as to block the suctioned air to separate the previously perfectly positioned part from the tubular sleeve.

It should be noted that the picking and placement device for small parts according to the invention is very particularly suitable for the field of odontology or microsurgery, but could also advantageously be used in other fields of the art without going beyond the scope of the invention.

Such a device may be autoclavable, reusable, sterilizable, or single-use and disposable.

### BRIEF DESCRIPTION OF THE DRAWINGS

The features of this device and its usage mode will be described in more detail in reference to the appended non-limiting drawings, in which:

FIG. 1 is a diagram showing a picking and placement device according to the invention,

FIGS. 2, 3 and 4 are diagrams illustrating the different steps for picking and placing an inlay core in a dental root.

### DETAILED DESCRIPTION OF THE EMBODIMENTS

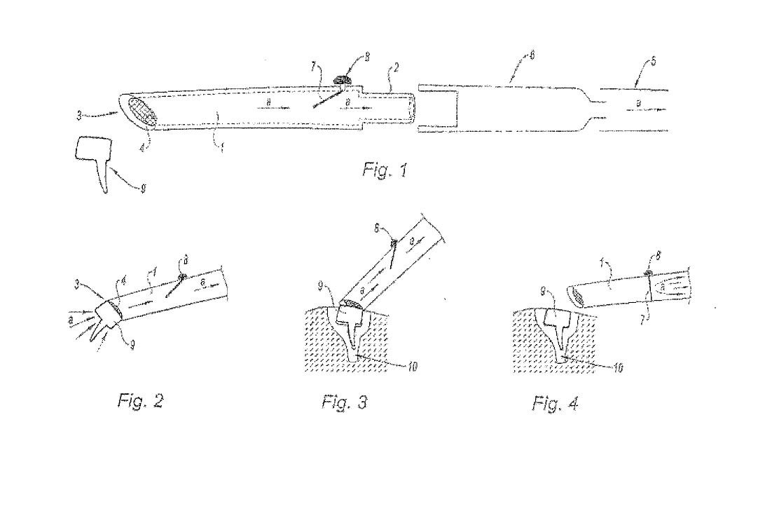

According to FIG. 1, the device is made up of a tubular sleeve 1 including a picking end 3 and a connection end provided with an end piece 2.

The picking end 3 of the tubular sleeve 1 has a slender shape and is equipped in its inner part with a foam or maintaining grate 4.

According to the illustrated example, the connection end piece 2 is connected on the suction system 5 of a dentist's chair by means of the sleeve 6 of a suction mirror.

The tubular sleeve 1 is further equipped in its inner part with a sealing flap 7 movable between an open position, in which it allows the passage of the aspirated air flow as diagrammed by the arrows a, and a closed position, in which it blocks that flow as illustrated in FIG. 4.

Actuating a pushbutton 8 protruding from the outer periphery of the tubular sleeve 1 makes it possible to move the sealing flap 7 between the open position and the closed position.

According to the figures, the tubular sleeve 1 thus equipped allows a practitioner to grasp an inlay core 9 to place it in a previously prepared dental root 10 shown diagrammatically in FIGS. 3 and 4.

According to FIG. 2, the first step of this placement process consists of bringing the picking end 3 of the tubular sleeve 1 into contact with the inlay core 9, which is then pressed against it under the action of the aspirated air flow a.

The presence of the foam or maintaining grate 4 makes it possible to prevent the inlay core 9 from being “swallowed” and driven by the air flow to the inner part of the tubular sleeve 1 toward the connection end piece 2. The inlay core 9 is thus perfectly maintained at the picking end 3 of the tubular sleeve 1 such that the practitioner can move said sleeve and precisely place the inlay core 9 in the cavity 10 of the dental root previously prepared as shown in FIG. 3.

According to FIG. 4, the practitioner can then actuate the pushbutton 8 to move the sealing flap 7 into the closed position so as to block the aspirated air flow.

The inlay core 9 positioned in the cavity 10 is then automatically separated from the tubular sleeve 1, which can be removed.

### NOMENCLATURE

1. Tubular sleeve
2. Connection end piece
3. Picking end
4. Foam or maintaining grate
5. Suction system
6. Sleeve of a suction mirror
7. Sealing flap
8. Pushbutton
9. Inlay core
10. Cavity

1-8. (canceled)

9. A tubular sleeve configured to grasp a small part, move it, and place it in a correct location in a patient's mouth, the tubular sleeve comprising:
a picking end;
a connection end provided with a connection end piece, the connection end piece being configured to connect to a suction system; and
an inner part between the picking end and the connection end, the inner part being equipped with a sealing flap configured to cooperate with a control device to move the sealing flap between an open position and a closed position, wherein:
the sealing flap, in the open position, allows passage of aspirated air flow from the suction system, the aspirated air flow being sufficient to pick up and suction the small part, and
the sealing flap, in the closed position, blocks the aspirated air flow to separate the small part from the tubular sleeve.

10. The tubular sleeve according to claim 9, wherein:
the suction system is a suction system of a dentist's chair, and
the small part is selected from the group comprising posts, pivots, inlay cores, crowns, and onlays.

11. The tubular sleeve according to claim 10, wherein the connection end piece of the tubular sleeve is connected indirectly to the suction system of the dentist's chair by a sleeve of a suction mirror.

12. The tubular sleeve according to claim 9, wherein the control device is a pushbutton protruding from an outer periphery of the tubular sleeve.

13. The tubular sleeve according to claim 9, wherein the picking end includes a maintaining element configured to allow the aspirated air flow to pass and configured to retain the small part at the picking end.

14. The tubular sleeve according to claim 9, wherein the picking end is slender.

15. The tubular sleeve according to claim 9, wherein the picking end is bent.

16. The tubular sleeve according to claim 9, wherein the picking end further includes a fitting configured to tilt or rotate the picked up small part.

17. A method of placing a small part in a correct location in a patient's mouth, the method comprising the steps of:
obtaining the tubular sleeve according to claim 9;
connecting the connection end piece of the tubular sleeve to the suction system;
operating the control device to move the sealing flap into the open position, thereby allowing the passage of the aspirated air flow from the suction system;
bringing the picking end of the tubular sleeve close to the small part so that the small part is picked up and suctioned by the aspirated air flow and so that the small part is retained at the picking end;
transporting the small part while retained at the picking end to a final location in the patient's mouth; and
operating the control device to move the sealing flap into the closed position, thereby blocking the aspirated air flow, to separate the small part from the tubular sleeve and to position the small part at the first location, wherein:
the small part is selected from the group comprising posts, pivots, inlay cores, crowns, and onlays, and
the suction system is a suction system of a dentist's chair.

18. The method according to claim 17, wherein the connection end piece of the tubular sleeve is connected indirectly to the suction system of the dentist's chair by a sleeve of a suction mirror.

19. A tubular sleeve for grasping a small part, moving it, and placing it in a correct location in a patient's mouth, the tubular sleeve comprising:
a picking end;
a connection end provided with a connection means for connecting to a suction means; and
an inner part between the picking end and the connection end, the inner part being equipped with a sealing means cooperating with a control means for moving the sealing means between an open position and a closed position, wherein:
the sealing means, in the open position, allows passage of aspirated air flow from the suction means, the aspirated air flow being sufficient to pick up and suction the small part, and
the sealing means, in the closed position, blocks the aspirated air flow to separate the small part from the tubular sleeve.

20. The tubular sleeve according to claim 19, wherein:
the suction means is a suction means of a dentist's chair, and
the small part is selected from the group comprising posts, pivots, inlay cores, crowns, and onlays.

21. The tubular sleeve according to claim 20, wherein the connection means of the tubular sleeve is connected indirectly to the suction means of the dentist's chair by a sleeve of a suction mirror.

22. The tubular sleeve according to claim 19, wherein the control means is a pushbutton protruding from an outer periphery of the tubular sleeve.

23. The tubular sleeve according to claim 19, wherein the picking end includes a maintaining means for allowing the aspirated air flow to pass and for retaining the small part at the picking end.

24. The tubular sleeve according to claim 19, wherein the picking end is slender.

25. The tubular sleeve according to claim 19, wherein the picking end is bent.

26. The tubular sleeve according to claim 19, wherein the picking end further includes a fitting means for tilting or rotating the picked up small part.

27. A method of placing a small part in a correct location in a patient's mouth, the method comprising the steps of:
obtaining the tubular sleeve according to claim 19;
connecting the connection means of the tubular sleeve to the suction means;
operating the control means to move the sealing means into the open position, thereby allowing the passage of the aspirated air flow from the suction means;
bringing the picking end of the tubular sleeve close to the small part so that the small part is picked up and suctioned by the aspirated air flow and so that the small part is retained at the picking end;
transporting the small part while retained at the picking end to a final location in the patient's mouth; and
operating the control means to move the sealing means into the closed position, thereby blocking the aspirated air flow, to separate the small part from the tubular sleeve and to position the small part at the final location, wherein:
the small part is selected from the group comprising posts, pivots, inlay cores, crowns, and onlays, and
the suction means is a suction means of a dentist's chair.

28. The method according to claim 27, wherein the connection means of the tubular sleeve is connected indirectly to the suction means of the dentist's chair by a sleeve of a suction mirror.
